(19) United States
(12) Patent Application Publication
(10) Pub. No.: US 2008/0210387 A1
(43) Pub. Date: Sep. 4, 2008

(54) Structure for curtain positioning

(76) Inventor: Chin-Chien Yang, Taipei City (TW)

Correspondence Address: BACON & THOMAS, PLLC, 625 SLATERS LANE, FOURTH FLOOR, ALEXANDRIA, VA, 22314, US

(21) Appl. No.: 11/712,979

(22) Filed: Mar. 2, 2007

(51) Int. Cl. E06B 9/36

(52) U.S. Cl. 160/168.1 V; 160/341

(57) ABSTRACT

A structure for curtain positioning provided for direct pushing/pulling of a user to draw and release a curtain, the structure comprises: a positioning frame, at least two positioning rope sets, a rotating axle, at least two reel sets, and a positioning control box; when the user stops pushing and pulling the curtain, the curtain can be kept immediately at the position when he stops; when the curtain (such as a horizontal blind) is composed of multiple elongate strips, the curtain can be pushed and pulled slightly to adjust the angular position against the horizon of the blades of the curtain.

### BACKGROUND OF THE INVENTION

1. Field of the Invention

The present invention relates to a structure for curtain positioning by which the two lateral sides of a curtain are raised/lowered synchronically in equal levels, and especially to a structure for curtain positioning provided for direct pushing/pulling of a user to draw and release the curtain.

2. Description of the Prior Art

There are many kinds of horizontally raising/lowering curtains such as: horizontal blinds, Roman shades, pleated shades etc., the mode of operation of conventional horizontally raising/lowering curtains is that by which a user can manipulate a manipulating rope and a manipulating rod to indirectly draw, release and adjust the curtain; taking a normal horizontal blind as an example, generally, a manipulating rope is hung there for a user to draw and release the curtain, and a manipulating rod is provided for the user to adjust the angular position against the horizon of the blades of the curtain, in such operations, some complicated pulling and linking up mechanisms (such as the conventional elements including connecting ropes, gearing pulleys, reverse positioning elements etc. which are not necessarily to be described further) are involved, in order to get an effect that the two lateral sides of the curtain are raised/lowered synchronically in equal levels and that the user can adjust the angular position of the curtain.

However, having the manipulating rope and the manipulating rod can affect the esthetic appearance of the curtain, and even can have a problem of safety of wrapping the neck of a child who is manipulating the rope; for the purpose of keep safety and beautiful appearance of the curtain, the pulling and linking up mechanisms in relating to operating of the manipulating rope and rod must be hidden. For example, the pulling and linking up mechanisms are hidden in a positioning frame provided on the top end of the curtain; and by the problems of being unfavorable for having beautiful appearance and for utilization of space, and that the space inside of the positioning frame for receiving the pulling and linking up mechanisms is small, related assembling and maintenance are quite difficult.

### SUMMARY OF THE INVENTION

The primary object of the present invention is to provide a structure for curtain positioning by which the two lateral sides of a curtain are raised/lowered synchronically in equal levels, the structure needs not to be provided with the manipulating rope and the manipulating rod mentioned in the “mode of operation of conventional horizontally raising/lowering curtains” stated above, and can allow a user to directly push and pull to draw and release for adjusting the curtain such as a horizontal blind, Roman shade, pleated shade etc. of which the two lateral sides of the curtain require to be raised/lowered synchronically in equal levels. When the curtain (such as a horizontal blind) is composed of multiple elongate strips, the curtain can be pushed and pulled slightly to adjust the angular position against the horizon of the blades of the curtain.

The structure for curtain positioning of the present invention comprises: a positioning frame; at least two positioning rope sets extending downwards from the positioning frame for positioning of corresponding parts of the curtain; a rotating axle horizontally provided in the positioning frame; at least two reel sets synchronically moving with the rotating axle, each reel set includes at least a reel linking up with the rotating axle, a drawing rope of which one end is reeled up on the reel and the other end is used to draw and release the curtain; and a positioning control box provided in the positioning frame, the positioning control box has therein at least a bush as a follower member of and for extending therethrough of the rotating axle, a first cogged winch linking up with the bush, a second cogged winch linking up with the first cogged winch, a resisting reed having an end reeled on the first cogged winch and having the other end engaged on the second cogged winch; the first cogged winch is provided thereon with a first bevel gear synchronically rotated with the first cogged winch, and the bush is provided thereon with a second bevel gear in cooperation with the first bevel gear. Thereby the positioning control box provides a resisting force to prevent the curtain from dropping by its own gravity, surely the resisting force provided by the positioning control box is not necessarily completely accurately identical to the gravity of the curtain, it is only necessary that the difference between the resisting force and the gravity of the curtain is smaller than the natural resisting forces created in the structure for curtain positioning (such as: the maximum stationary friction of the structure for curtain positioning itself and among the members in the structure for curtain positioning); thereby, when a user directly pushes and pulls the curtain, he can draw and release for adjusting the curtain, he needs not to use some other indirect way to adjust the curtain; when the user stops pushing and pulling the curtain, the curtain can be kept immediately at the position when he stops.

Secondly, when the abovementioned curtain composed of multiple elongate strips is in the form of a horizontal blind, the drawing rope can be extended downwards from above through each elongate strip and connected to the bottommost elongate strip; each reel is provided with a synchronous pulley; and each positioning rope set at least includes a main positioning cable of which the top is hung on the synchronous pulley and of which two ends pend parallely to each other, and includes a plurality of transverse cables provided between the two ends pending parallely to each other of the main positioning cable for mounting the elongate strips; the area between the main positioning cable and the synchronous pulley is in the state of having a slight frictional impedance, that is a non-tightly matching state. When the user slightly pushes and pulls the curtain, the rotating axle will synchronically linking up with the reel sets to synchronically reel in/off the drawing ropes; at this time, the main positioning cable on the top of each of the positioning rope sets is moved by the synchronous pulley to render the transverse cables 22 and the elongate strips 101 mounted on the transverse cables 22 to get change in inclination degree; when the transverse cables are inclined to make the elongate strips engage with one another, by virtue that the area between the main positioning cable and the synchronous pulley is in the state of having a slight frictional impedance—that is a non-tightly matching state, the synchronous pulley can still rotate in an idle mode without hindering operation of the reels; in other words, the user can adjust the angular position against the horizon of the blades of the curtain.

In comparison with the prior art, the present invention at least has the following advantages:
1. The present invention needs not to provide the manipulating rope and the manipulating rod mentioned in the conventional techniques.
2. The members including the positioning frame, the positioning rope sets, the rotating axle, the reel sets and the positioning control box are all able to be modularized and are suitable for being produced for individual items of them, this can elevate convenience of production, assembling and maintenance.
3. When the curtain is a horizontal blind, the curtain positioning structure of the present invention is provided for a user to directly and slightly push and pull the curtain to adjust the angular position against the horizon of the blades of the curtain.

The present invention will be apparent in its mode of practicing according to its technical measures after reading the detailed description of the preferred embodiment thereof in reference to the accompanying drawings.

### BRIEF DESCRIPTION OF THE DRAWINGS

FIG. 1 is a schematic view showing the appearance of the most preferred embodiment of the present invention;

FIG. 2 is a perspective view showing the appearance of a positioning control box and a reel set of the most preferred embodiment of the present invention;

FIG. 3 is an anatomic perspective view of the positioning control box of the most preferred embodiment of the present invention;

FIG. 4 is a schematic view showing an angular position against the horizon of the blades of the curtain of the most preferred embodiment of the present invention;

FIG. 5 is another schematic view showing the angular position against the horizon of the blades of the curtain of the most preferred embodiment of the present invention;

FIG. 6 is a further schematic view showing the angular position against the horizon of the blades of the curtain of the most preferred embodiment of the present invention;

FIG. 7 is a schematic view showing a positioning rope set of the most preferred embodiment of the present invention.

### DETAILED DESCRIPTION OF THE PREFERRED EMBODIMENT

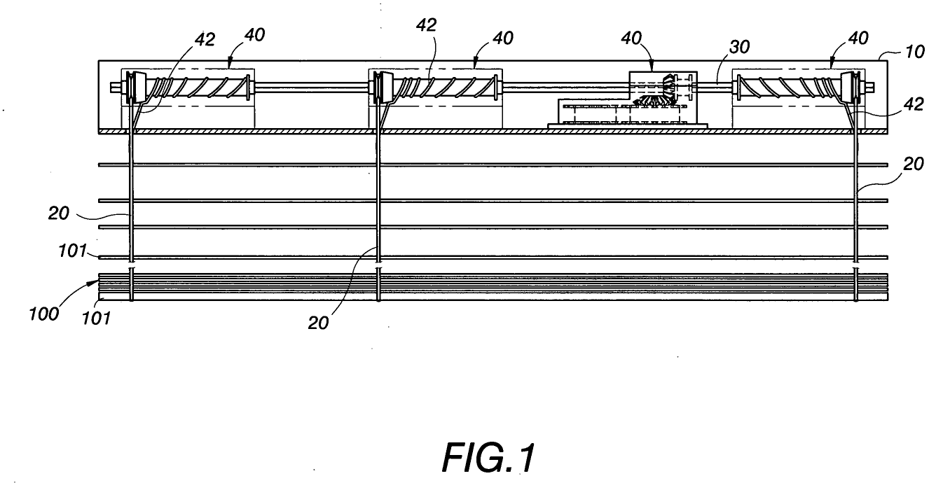

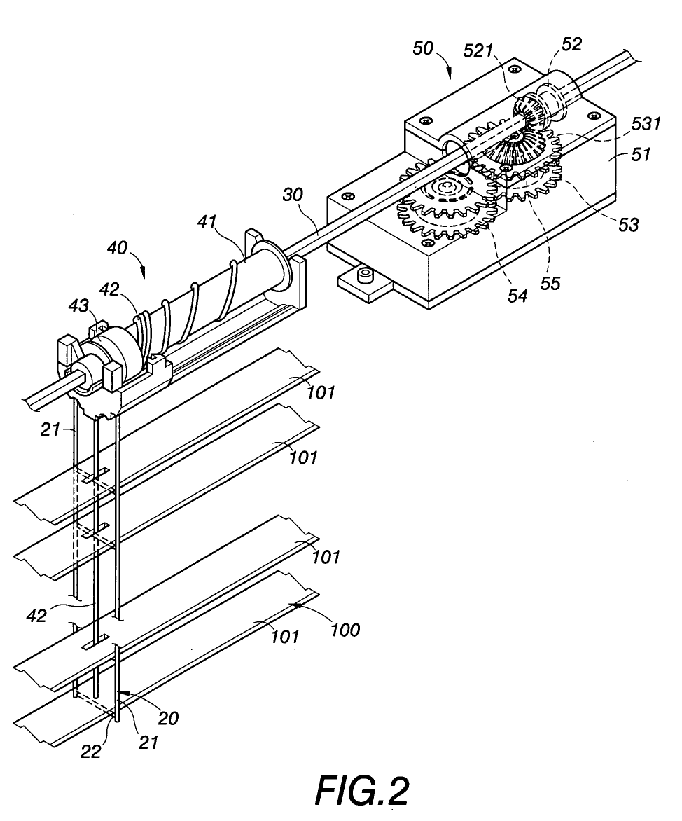

Referring to FIGS. 1 and 2 which are respectively a schematic view showing the appearance of the most preferred embodiment of the present invention and a perspective view showing the appearance of a positioning control box 50 and a reel set 40 of the most preferred embodiment of the present invention, it is depicted in these drawings that the structure for curtain positioning of the present invention comprises: a positioning frame 10; at least two positioning rope sets 20, a rotating axle 30, at least two reel sets 40 and the positioning control box 50; a curtain 100 in this embodiment is depicted as a horizontal blind for the convenience of specification, the curtain 100 is composed of multiple elongate strips 101 which are arranged from the uppermost one to the lowermost one all in horizontal disposition.

The positioning frame 10 is provided above the curtain 100 for directly or indirectly positioning of the curtain 100 for the convenience of providing of the curtain 100 at a window, on a wall or some other structure; the positioning frame 10 has therein a receiving space for receiving the rotating axle 30, the reel sets 40 and the positioning control box 50.

The positioning rope sets 20 are extended downwards from the positioning frame 10 for positioning of corresponding parts of the curtain 100; each positioning rope set 20 at least includes a main positioning cable 21 of which two ends pend parallely to each other, and includes a plurality of transverse cables 22 provided between the two ends pending parallely to each other of the main positioning cable 21 for mounting the elongate strips 101.

The rotating axle 30 is provided in the positioning frame 10 horizontally, for instance, it is provided in the positioning frame 10 horizontally by means of the reel sets 40 and the positioning control box 50.

The reel sets 40 are provided in the positioning frame 10 synchronically moving with the rotating axle 30, each reel set 40 includes at least a reel 41 linking up with the rotating axle 30, a drawing rope 42 of which one end is reeled up on the reel 41 and the other end is used to draw the and release the curtain 100; the drawing rope 42 can be extended downwards from above through each elongate strip 101 and connected to the bottommost elongate strip 101. Each reel 41 is provided with a synchronous pulley 43 for hanging thereon of the top of the main positioning cable 21 of a positioning rope set 20; the main positioning cable 21 and the synchronous pulley 43 mutually are in a non-tightly matching state.

The positioning control box 50 is provided in the positioning frame 10 for extending therethrough of the rotating axle 30 to provide a suitable resisting force to resist rotation of the rotating axle 30.

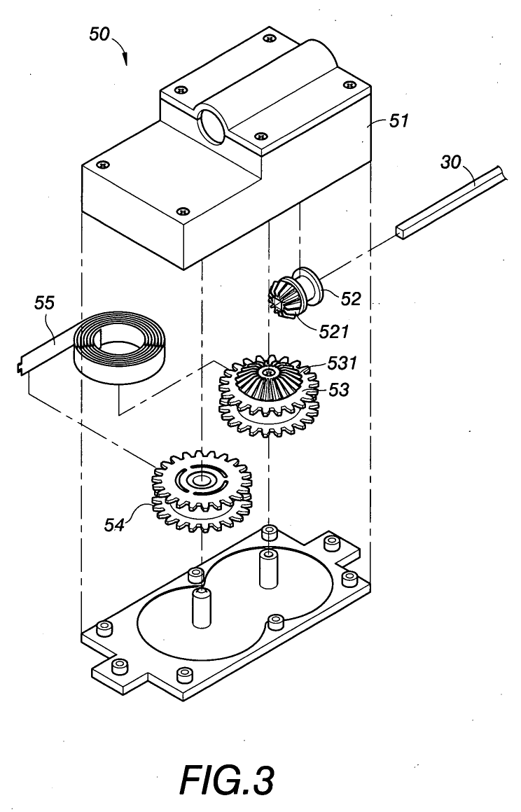

Concerning combination of the positioning control box 50, please refer to FIGS. 2 and 3, wherein FIG. 3 is an anatomic perspective view of the positioning control box 50 of the most preferred embodiment of the present invention, the positioning control box 50 is provided in its box body 51 at least with a bush 52 as a follower member of and for extending therethrough of the rotating axle 30, a first cogged winch 53 linking up with the bush 52, a second cogged winch 54 linking up with the first cogged winch, and a resisting reed 55 having an end reeled on the first cogged winch 53 and having the other end engaged on the second cogged winch 54; wherein the first cogged winch 53 is provided thereon with a first bevel gear 531 synchronically rotated with the first cogged winch 53, and the bush 52 is provided thereon with a second bevel gear 521 in cooperation with the first bevel gear 531.

It can be understood from the content disclosed above with FIGS. 1 to 3 that, the positioning control box 50 provides a resisting force to prevent the curtain 100 from dropping by its own gravity; when a user directly pushes and pulls the curtain 100, he can draw and release for adjusting the curtain 100, he needs not to use some other indirect way to adjust the curtain 100; when the user stops pushing and pulling the curtain 100, the curtain 100 can be kept immediately at the position when he stops. The curtain 100 depicted in the drawings is a horizontal blind for the convenience of specification, in practicing, the curtain 100 can be one of those including Roman shades, pleated shades etc. that have the characteristic of raising/lowering in keeping their horizontal position.

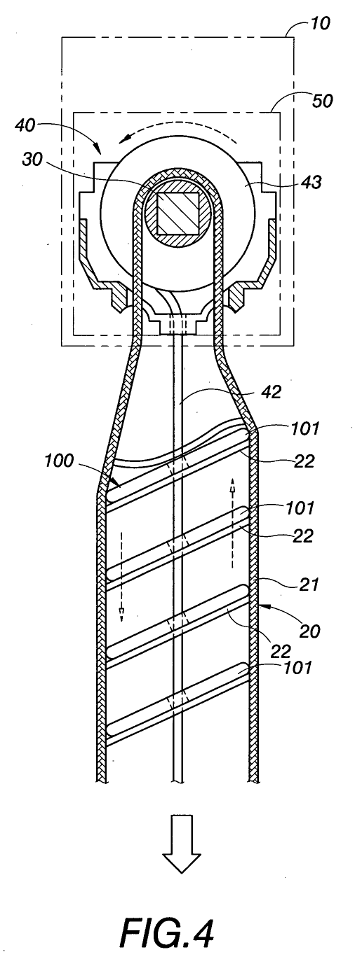

Referring to FIGS. 1 and 4, wherein FIG. 4 is a schematic view showing an angular position against the horizon of the blades of the curtain 100 of the most preferred embodiment of the present invention, when the user slightly pulls down the curtain 100 to rotate the synchronous pulley 43 by drawing of the drawing rope 42 (for description, the direction of counterclockwise rotating is depicted to represent the rotation of the synchronous pulley 43), at this time, the positioning rope sets 40 will also be moved synchronously by linking up of the rotating axle 30; by virtue that the area between the main positioning cable 21 on the top of the positioning rope sets 20 and the synchronous pulley 43 is in the state of having a slight frictional impedance, the main positioning cable 21 will be moved by the main positioning cable 21 to render the transverse cables 22 and the elongate strips 101 mounted on the transverse cables 22 to get change in inclination degree.

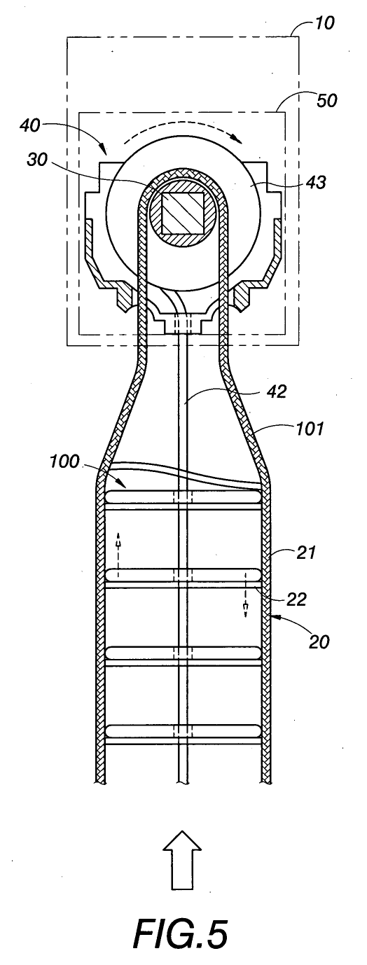

Referring to FIGS. 1 and 5, wherein FIG. 5 is another schematic view showing the angular position against the horizon of the blades of the curtain 100 of the most preferred embodiment of the present invention, when the user slightly pushes up the curtain 100, the user thus bears the weight of the curtain 100, thus in the mean time, the positioning rope sets 40 are allowed to be manipulated for reeling in by means of the rotating axle 30 by virtue that the weight of the curtain 100 is not balanced by the resisting force of the positioning control box 50 now; at this time, the direction of rotating of the synchronous pulley 43 is contrary to that shown in FIG. 4 (the direction of clockwise rotating is depicted to represent the rotation of the synchronous pulley 43 in this drawing), so that the transverse cables 22 and the elongate strips 101 mounted on the transverse cables 22 get change in inclination degree in the direction contrary to the original one. In other words, the user can slightly push and pull the curtain 100 to adjust the angular position against the horizon of the blades of the curtain 100.

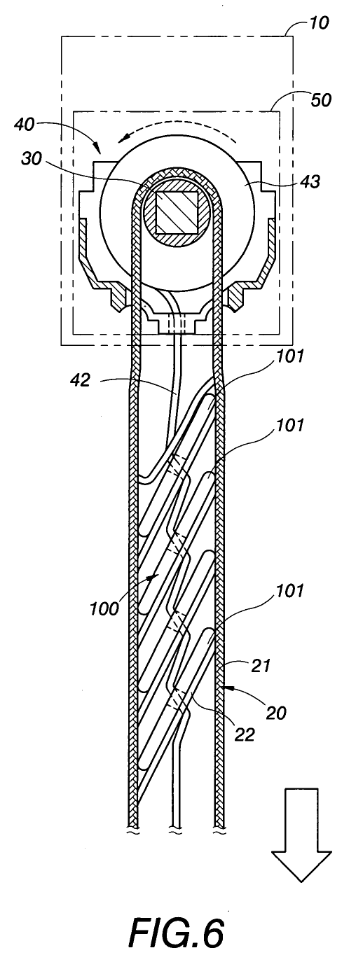

FIG. 6 is a further schematic view showing the angular position against the horizon of the blades of the curtain 100 of the most preferred embodiment of the present invention, by virtue that the area between the main positioning cable 21 and the synchronous pulley 43 is in the state of having a slight frictional impedance—that is a non-tightly matching state, when the transverse cables 22 are inclined to make the elongate strips 101 engage with one another, the synchronous pulley 43 can still rotate in an idle mode without hindering operation of the reels 40.

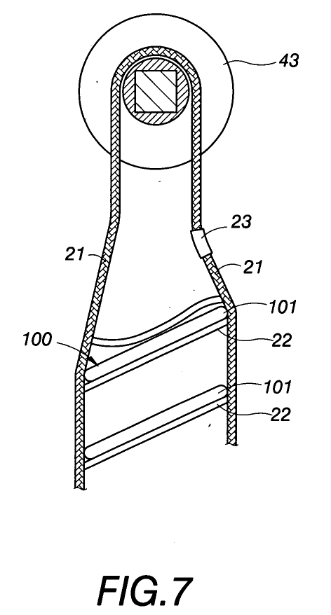

Each main positioning cable 21 in the above disclosed (in all the drawings) is integrally formed with a corresponding one of the positioning rope sets 20; however, in practicing, for the convenience of producing, each positioning rope set 20 can be reformed from a conventional rope ladder; as shown in FIG. 7, the conventional rope ladder includes a main positioning cable 21 pending vertically and a plurality of transverse cables 22 provided between two side sections of the main positioning cable 21, the two side sections of the main positioning cable 21 are connected with each other (for instance connected by sewing or by means of a connecting element 23), namely, the two side sections of the main positioning cable 21 are integrally connected with each other at the middle top of them to form a circle matching with the synchronous pulley 43. Alternatively, the topmost transverse cable 22 can be regarded as the connecting element 23 between the two side sections of the main positioning cable 21 (not shown), thus the top of the main positioning cable 21 can form a circle matching with the synchronous pulley 43.

The embodiment depicted and stated above is only for illustrating the present invention, and not for giving any limitation to the scope of the present invention. It will be apparent to those skilled in this art that various equivalent modifications or changes without departing from the spirit of this invention shall also fall within the scope of the appended claims.

1. A structure for curtain positioning comprising:
a positioning frame for positioning a curtain;
a rotating axle horizontally provided in said positioning frame;
at least two reel sets synchronically moving with said rotating axle, each of said reel sets includes at least a reel linking up with said rotating axle, a drawing rope of which one end is reeled up on said reel and the other end is used to draw and release said curtain; and
a positioning control box provided in said positioning frame, said positioning control box has therein at least a bush as a follower member of and for extending therethrough of said rotating axle, a first cogged winch linking up with said bush, a second cogged winch linking up with said first cogged winch, a resisting reed having an end reeled on said first cogged winch and having other end engaged on said second cogged winch.

2. The structure for curtain positioning as in claim 1, wherein: said first cogged winch is provided thereon with a first bevel gear synchronically rotated with said first cogged winch, and said bush is provided thereon with a second bevel gear in cooperation with said first bevel gear.

3. The structure for curtain positioning as in claim 1, wherein: said structure further comprises at least two positioning rope sets extending downwards from said positioning frame for positioning of said curtain; said curtain is composed of multiple elongate strips arranged from an uppermost one to a lowermost one all in horizontal disposition, said drawing rope is extended downwards from above through each of said elongate strips and connected to a bottommost one of said elongate strips.

4. The structure for curtain positioning as in claim 3, wherein: each of said reels is provided with a synchronous pulley; each of said positioning rope sets at least includes a main positioning cable of which a top is hung on said synchronous pulley and of which two ends pend parallely to each other, and includes a plurality of transverse cables provided between said two ends pending parallely to each other of said main positioning cable for mounting said elongate strips.

5. The structure for curtain positioning as in claim 4, wherein: an area between said main positioning cable and said synchronous pulley is in a state of having a slight frictional impedance, which state thus is a non-tightly matching state.
